(19) United States
(12) Patent Application Publication
(10) Pub. No.: US 2017/0028430 A1
(43) Pub. Date: Feb. 2, 2017

(54) Atomizing Assembly and Atomizer Having the Same

(71) Applicant: Taiwan Puritic Corp., Hsinchu County (TW)

(72) Inventor: Chun-Tai CHIANG, New Taipei City (TW)

(21) Appl. No.: 14/882,103

(22) Filed: Oct. 13, 2015

(30) Foreign Application Priority Data
Jul. 29, 2015 (TW) 104212164

(51) Int. Cl. B05B 17/00; B05B 15/06; B05B 1/12

(52) U.S. Cl. CPC B05B 17/0646; B05B 1/12; B05B 15/065

(57) ABSTRACT

The present invention relates to an atomizing assembly and an atomizer having the same. The atomizing assembly comprises a containing part and an atomizing part. The containing part includes a containing body defining a containing space for containing a liquid to be atomized, and the containing body has a recess with a first pattern. The atomizing part includes an atomizing mechanism and an atomizing electric-connection portion electrically connected with the atomizing mechanism. The atomizing mechanism has a second pattern corresponding to the first pattern. The second pattern of the atomizing mechanism is press-fitted to the first pattern of the recess such that the atomizing mechanism is detachably disposed in the recess of the containing body. The present invention is easy to assemble/disassemble, and the parts thereof can be closely press-fitted to each other without using any fixing element.

### BACKGROUND OF THE INVENTION

1. Field of the Invention

The present invention relates to an atomizing assembly and an atomizer having the same, particularly to an atomizing assembly whose containing part and atomizing part can be press-fitted to or separated from each other, and an atomizer having the same.

2. Description of the Prior Art

Generally to speak, an oscillation type atomizer uses a nozzle plate and an oscillation plate to convert a liquid into tiny liquid droplets and spray them out. In a conventional oscillation type atomizer, the atomizing assembly and the atomizer body are fabricated integrally. Thus, the conventional oscillation type atomizer is likely to have malfunctions or current leakage caused by liquid infiltration while it is resupplied with liquid. Further, the user may experience inconvenience in replacing related parts.

Some conventional designs were proposed to solve the abovementioned problems, wherein the atomizing assembly and the atomizer body are fabricated into separate structures. In these improved designs, the joint regions of the atomizing assembly and the atomizer body are normally planar structures. While the atomizer is operating, oscillation converts the liquid into mist. However, oscillation force may also cause the liquid to overflow from the gap between the planer joint regions, which would waste the liquid and may damage the device. If the atomizing assembly and the atomizer body are joined with fixing elements or an adhesive, the fabrication cost thereof may increase.

### SUMMARY OF THE INVENTION

In order to overcome the drawbacks of the conventional technology, the present invention proposes an atomizing assembly and an atomizer having the same, wherein the containing part and the atomizing part of the atomizing assembly have corresponding press-fit structures, whereby the containing part and the atomizing part are easy to assemble and disassemble, and whereby the containing part and the atomizing part can be closely press-fitted to each other without using any fixing elements, and whereby are avoided the problems of liquid waste and device damage caused by liquid leakage occurring in the conventional atomizing assembly.

One objective of the present invention is to provide an atomizing assembly, which comprises a containing part including a containing body defining a containing space for containing a liquid to be atomized; and an atomizing part including an atomizing mechanism and an atomizing electric-connection portion electrically connected with the atomizing mechanism, wherein the containing body has a recess with a first pattern, and wherein the atomizing mechanism has a second pattern corresponding to the first pattern, and wherein the atomizing mechanism is detachably installed in the recess of the containing body via press-fitting the second pattern to the first pattern of the recess.

In one embodiment, the first pattern is a convex pattern, and the second pattern is a concave pattern; the convex pattern matches the concave pattern.

In one embodiment, the first pattern is a concave pattern, and the second pattern is a convex pattern; the concave pattern matches the convex pattern.

In one embodiment, the first pattern and the second pattern are annular patterns.

In one embodiment, the atomizing assembly further comprises a fixing cover, whose shape is corresponding to the atomizing mechanism and the atomizing electric-connection portion, and which is used to cover the atomizing mechanism and the atomizing electric-connection portion and fix them to the containing body.

Another objective of the present invention is to provide an atomizer, which comprises the abovementioned atomizing assembly and a base seat, wherein the base seat includes a base electric-connection portion that is fabricated into a structure able to be electrically connected with the atomizing electric-connection portion.

Below, embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing an atomizing assembly according to one embodiment of the present invention;

FIG. 2a is an exploded view schematically showing an atomizing assembly according to one embodiment of the present invention;

FIG. 2b is an exploded view schematically showing an atomizing assembly according to another embodiment of the present invention;

FIG. 3 is a diagram schematically showing an atomizer according to one embodiment of the present invention; and

FIG. 4 is a diagram schematically showing a base seat of an atomizer according to one embodiment of the present invention.

### DESCRIPTION OF THE PREFERRED EMBODIMENT

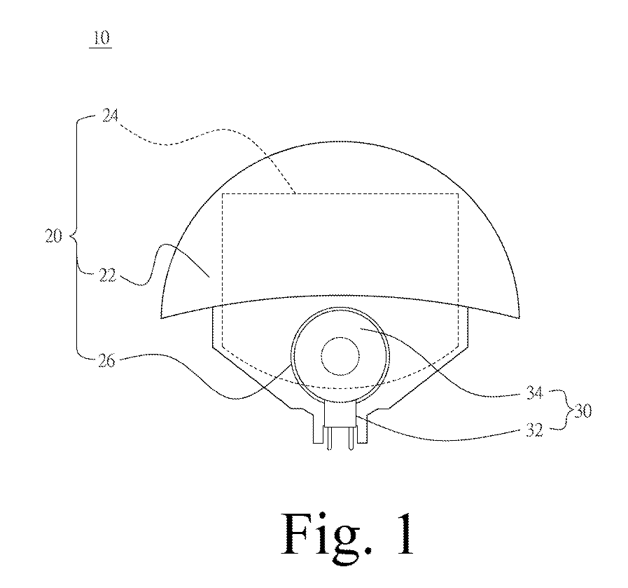

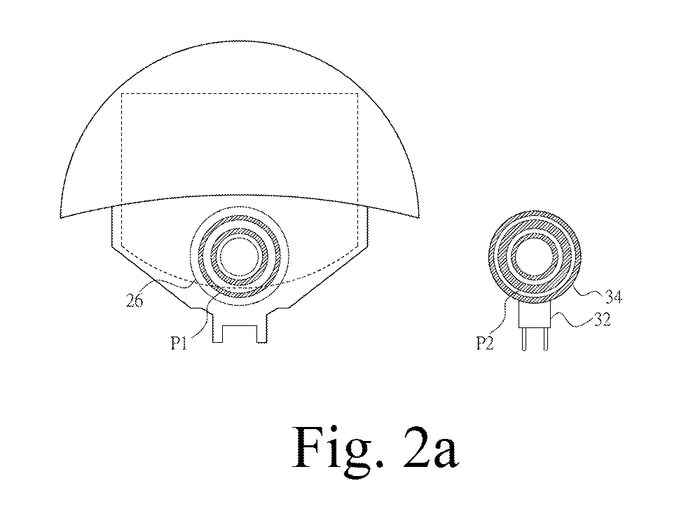

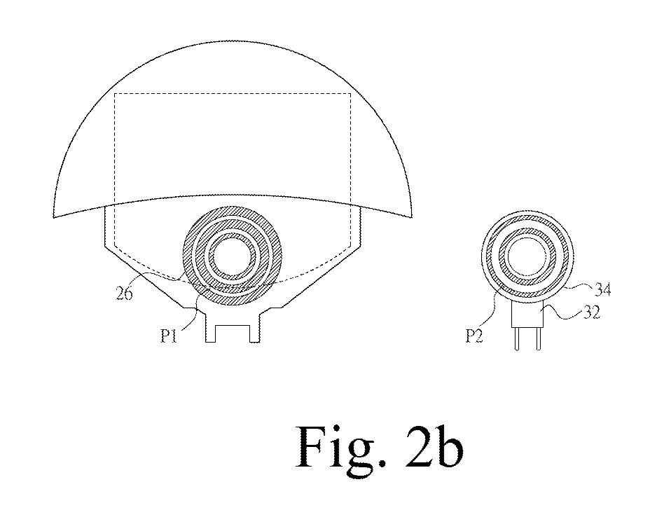

Refer to FIG. 1. The atomizing assembly 10 of the present invention comprises a containing part 20 and an atomizing part 30. The containing part 20 includes a containing body 22 defining a containing space 24 for containing a liquid (not shown in the drawing) to be atomized. The containing body 22 has a recess 26 with a first pattern P1 (as shown in FIG. 2a and FIG. 2b), which will be described in detail hereinafter. The atomizing part of the atomizing assembly 10 includes an atomizing mechanism 34 and an atomizing electric-connection portion 32 electrically connected with the atomizing mechanism 34. In one embodiment, the atomizing mechanism 34 is disposed corresponding to the recess 26 of the containing body 22.

Refer to FIG. 2a and FIG. 2b. The atomizing mechanism 34 has a second pattern P2 corresponding to the first pattern P1 of the recess 26. The atomizing mechanism 34 is detachably installed in the recess 26 of the containing body 22 via press-fitting the second pattern P2 to the first pattern P1 of the recess 26. In one embodiment, the first pattern P1 is a convex pattern, and the second pattern P2 is a concave pattern; the convex pattern is corresponding to the concave pattern and can be press-fitted to the concave pattern. In another embodiment, the first pattern P1 is a concave pattern, and the second pattern P2 is a convex pattern; the convex pattern is corresponding to the concave pattern and can be press-fitted to the concave pattern. It should be noted: the first pattern P1 and the second pattern P2, which are drawn to have annular shapes in the drawings, are only for exemplification. As long as the first pattern P1 and the second pattern P2 are corresponding to each other and can be press-fitted to each other, the present invention does not limit that the first pattern and the second pattern must have a specified shape.

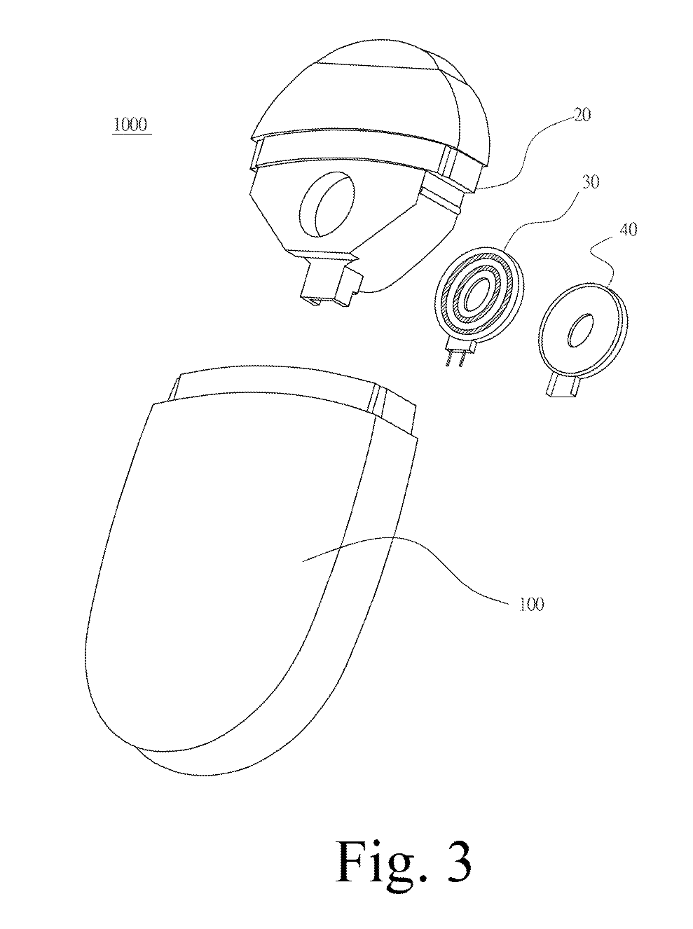

In one embodiment, the atomizing assembly of the present invention further comprises a fixing cover 40, as shown in FIG. 3. The fixing cover 40 is corresponding to the atomizing part 30. In other words, the shape of the fixing cover 40 is corresponding to the shapes of the atomizing mechanism 34 and the atomizing electric-connection portion 32, and the fixing cover 40 is used to cover the atomizing mechanism 34 and the atomizing electric-connection portion 32 and fix them to the containing part 20. In one embodiment, an adhesive agent or fixing elements are applied between the fixing cover 40 and the atomizing part 30 to enhance the connection and leakage resistance thereof.

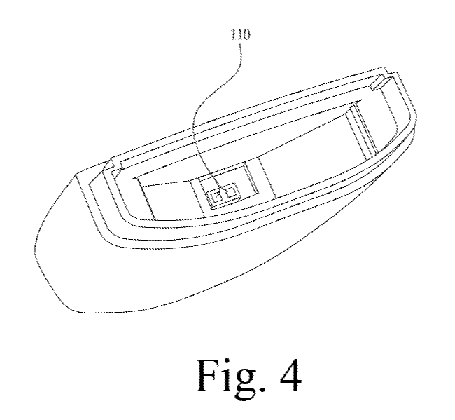

Refer to FIG. 3 and FIG. 4. The present invention also proposes an atomizer 1000, which further comprises a base seat 100 and the abovementioned atomizing assembly, which includes the containing part 20, the atomizing part 30 and the fixing cover 40. The base seat 100 includes a base electric-connection portion 110, which is fabricated into a structure able to be electrically connected with the atomizing electric-connection portion 32 of the atomizing part 30. The base electric-connection portion 110 can function as a power source or is electrically connected with a power source. Via the connection of the atomizing electric-connection portion 32 and the base electric-connection portion 110, the atomizing assembly 10 and the base seat 100 are assembled to form the atomizer 1000. In one embodiment, the atomizing electric-connection portion 32 is a group of pins; the atomizing assembly 10 is electrically connected with the base seat 100 in a pin-insertion way. According to requirement, the atomizer 1000 of the present invention can function as a sprayer of essence or perfume, a humidity modifier, a cosmetic moisturizer, or an applicator.

In conclusion, the present invention proposes an atomizing assembly, which comprises a containing part and an atomizing part respectively having a first pattern and a second pattern, wherein the first pattern and the second pattern are corresponding to each other and can be press-fitted to each other, whereby the containing part and the atomizing part can be detachably engaged with each other, and whereby the containing part and the atomizing part can be securely press-fitted to each other without using any fixing element, wherefore the present invention can effectively avoid liquid leakage, and wherefore the present invention can increase the utilization efficiency of the liquid and decrease the malfunction rate of the device.

What is claimed is:

1. An atomizing assembly comprising:
a containing part including a containing body defining a containing space for containing a liquid to be atomized, wherein said containing body has a recess with a first pattern; and
an atomizing part including an atomizing mechanism and an atomizing electric-connection portion electrically connected with said atomizing mechanism, wherein said atomizing mechanism has a second pattern corresponding to said first pattern, and wherein said second pattern of said atomizing mechanism is press-fitted to said first pattern of said recess to make said atomizing mechanism detachably installed in said recess of said containing body.

2. The atomizing assembly according to claim 1, wherein said first pattern is a convex pattern, and said second pattern is a concave pattern, and wherein said convex pattern and said concave pattern are corresponding to each other.

3. The atomizing assembly according to claim 1, wherein said first pattern is a concave pattern, and said second pattern is a convex pattern, and wherein said concave pattern and said convex pattern are corresponding to each other.

4. The atomizing assembly according to claim 2, wherein said first pattern has an annular shape, and said second pattern also has an annular shape.

5. The atomizing assembly according to claim 3, wherein said first pattern has an annular shape, and said second pattern also has an annular shape.

6. The atomizing assembly according to claim 1 further comprising a fixing cover, whose shape is corresponding to said atomizing mechanism and said atomizing electric-connection portion, and which is used to cover said atomizing mechanism and said atomizing electric-connection portion and fix said atomizing mechanism and said atomizing electric-connection portion to said containing part.

7. An atomizer comprising an atomizing assembly and a base seat, wherein the atomizing assembly comprising:
a containing part including a containing body defining a containing space for containing a liquid to be atomized, wherein said containing body has a recess with a first pattern; and
an atomizing part including an atomizing mechanism and an atomizing electric-connection portion electrically connected with said atomizing mechanism, wherein said atomizing mechanism has a second pattern corresponding to said first pattern, and wherein said second pattern of said atomizing mechanism is press-fitted to said first pattern of said recess to make said atomizing mechanism detachably installed in said recess of said containing body;
wherein said base seat has a base electric-connection portion, and wherein said base electric-connection portion is fabricated into a structure able to be electrically connected with said atomizing electric-connection portion.

8. The atomizer according to claim 7, wherein said first pattern is a convex pattern, and said second pattern is a concave pattern, and wherein said convex pattern and said concave pattern are corresponding to each other.

9. The atomizer according to claim 7, wherein said first pattern is a concave pattern, and said second pattern is a convex pattern, and wherein said concave pattern and said convex pattern are corresponding to each other.

10. The atomizer according to claim 8, wherein said first pattern has an annular shape, and said second pattern also has an annular shape.

11. The atomizer according to claim 9, wherein said first pattern has an annular shape, and said second pattern also has an annular shape.

12. The atomizer according to claim 7, further comprising a fixing cover, whose shape is corresponding to said atomizing mechanism and said atomizing electric-connection portion, and which is used to cover said atomizing mechanism and said atomizing electric-connection portion and fix said atomizing mechanism and said atomizing electric-connection portion to said containing part.
